(19) United States
(12) Patent Application Publication
(10) Pub. No.: US 2024/0283174 A1
(43) Pub. Date: Aug. 22, 2024

(54) REWORKABLE PRESS-FIT LEG

(71) Applicant: Molex, LLC, Lisle, IL (US)

(72) Inventors: Yu-Da Liu, Guangdong (CN); Lie Chen, Maumelle, AR (US)

(21) Appl. No.: 18/136,356

(22) Filed: Apr. 19, 2023

(30) Foreign Application Priority Data
Feb. 17, 2023 (CN) 202310135781.4

(51) Int. Cl. H01R 12/58

(52) U.S. Cl. CPC H01R 12/585

(57) ABSTRACT

Various aspects of reworkable press-fit legs are described. In one example, a press-fit leg includes a flat beam extension region, a bent beam region, and a head region. Extending along a longitudinal axis of the leg, the bent beam region of the leg is positioned between the flat beam extension region and the head region of the leg. The bent beam region curves apart and away from the longitudinal axis of the leg, along a segment of a circle. The bent beam region and bent beams are compressible and can extend in length to some extent when inserted into mounting apertures. When removed from the mounting apertures, the bent beam regions also bend back to their original shapes, which facilitates rework of cages and other housings including the legs.

### RELATED APPLICATIONS

This application claims priority to Chinese Patent Application Serial No. 202310135781.4, filed Feb. 17, 2023, which is incorporated herein by reference in its entirety.

### BACKGROUND

Connectors, connector assemblies, and housings for connectors are important structural and functional components in many computing and data interconnect systems. A number of different connectors are used for power and controls circuits of computing and data interconnect systems, for data connections of computing and data interconnect systems, and for related purposes. Robots and automation tools can be used for some connector-assembly tasks, although many connectors and other parts of computing and data interconnect systems are still assembled by hand.

### SUMMARY

Various aspects of press-fit legs are described. In one example, a press-fit leg includes a flat beam extension region, a bent beam region, and a head region. Extending along a longitudinal axis of the leg, the bent beam region of the leg is positioned between the flat beam extension region and the head region of the leg. The bent beam region extends along a segment of a circle and curves apart and away from the longitudinal axis of the leg. The segment of the circle extends between a chord of the circle defined between points where the longitudinal axis of the leg intersects the circle.

In another example, the bent beam region comprises at least two counter-extending bent beams, such as two, three, four, or more counter-extending bent beams. The bent beams are separated by longitudinal slits in the bent beam region. The longitudinal slits extend longitudinally parallel to the longitudinal axis of the leg in one example.

In other aspects of the embodiments, the press-fit legs described herein include two lateral surfaces and two side surfaces. In the bent beam region, the two side surfaces extend parallel to the longitudinal axis of the leg and the two lateral surfaces are curved apart and away from the central longitudinal axis of the leg. In the head region, the two lateral surfaces taper toward the longitudinal axis of the leg and the two side surfaces curve inward and toward the longitudinal axis of the leg.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example interconnect assembly according to various embodiments of the present disclosure.

FIG. 1B illustrates an attachment leg in the interconnect assembly according to various examples described herein.

FIG. 2A illustrates a perspective view of a press-fit leg according to various aspects of the embodiments described herein.

FIG. 2B illustrates a first side view of the press-fit leg shown in FIG. 2A according to various aspects of the embodiments described herein.

FIG. 2C illustrates a second side view of the press-fit leg shown in FIG. 2A according to various aspects of the embodiments described herein.

FIG. 2D illustrates a bottom-up view of the press-fit leg shown in FIG. 2A according to various aspects of the embodiments described herein.

FIG. 2E illustrates another side view of the press-fit leg shown in FIG. 2A according to various aspects of the embodiments described herein.

FIG. 3A illustrates a perspective view of another press-fit leg according to various aspects of the embodiments described herein.

FIG. 3B illustrates a first side view of the press-fit leg shown in FIG. 3A according to various aspects of the embodiments described herein.

FIG. 3C illustrates a second side view of the press-fit leg shown in FIG. 3A according to various aspects of the embodiments described herein.

FIG. 3D illustrates a bottom-up view of the press-fit leg shown in FIG. 3A according to various aspects of the embodiments described herein.

FIG. 4A illustrates a perspective view of another press-fit leg according to various aspects of the embodiments described herein.

FIG. 4B illustrates a first side view of the press-fit leg shown in FIG. 4A according to various aspects of the embodiments described herein.

FIG. 4C illustrates a second side view of the press-fit leg shown in FIG. 4A according to various aspects of the embodiments described herein.

FIG. 4D illustrates a bottom-up view of the press-fit leg shown in FIG. 4A according to various aspects of the embodiments described herein.

FIG. 5A illustrates a perspective view of another press-fit leg according to various aspects of the embodiments described herein.

FIG. 5B illustrates a first side view of the press-fit leg shown in FIG. 5A according to various aspects of the embodiments described herein.

FIG. 5C illustrates a second side view of the press-fit leg shown in FIG. 5A according to various aspects of the embodiments described herein.

FIG. 5D illustrates a bottom-up view of the press-fit leg shown in FIG. 5A according to various aspects of the embodiments described herein.

FIG. 6A illustrates an example of the press-fit leg shown in FIG. 4B according to various aspects of the embodiments described herein.

FIG. 6B illustrates an example of the press-fit leg shown in FIG. 6A, molded or inserted into a wall or other housing, according to various aspects of the embodiments described herein.

FIG. 7A illustrates an example of an elongated aperture into which the press-fit legs described herein may be inserted according to various aspects of the embodiments described herein.

FIG. 7B illustrates an example of a press-fit leg that has been inserted into an elongated aperture according to various aspects of the embodiments described herein.

### DETAILED DESCRIPTION OF THE PREFERRED EMBODIMENTS

Connector housings and other assemblies are often secured over printed circuit boards (PCBs) and other substrates. Pins, legs, and other mechanical attachment mechanisms can be relied upon in some cases to help secure the housings and assemblies over PCBs and other substrates. In the context outlined above, various aspects of reworkable press-fit legs are described herein. In one example, a press-fit leg includes a flat beam extension region, a bent beam region, and a head region. Extending along a longitudinal axis of the leg, the bent beam region of the leg is positioned between the flat beam extension region and the head region of the leg. The bent beam region curves apart and away from the longitudinal axis of the leg, along a segment of a circle. The bent beam region and bent beams are compressible and can extend in length to some extent when inserted into mounting apertures. When removed from the mounting apertures, the bent beam regions also bend back to their original shapes, which facilitates rework of cages and other housings including the legs.

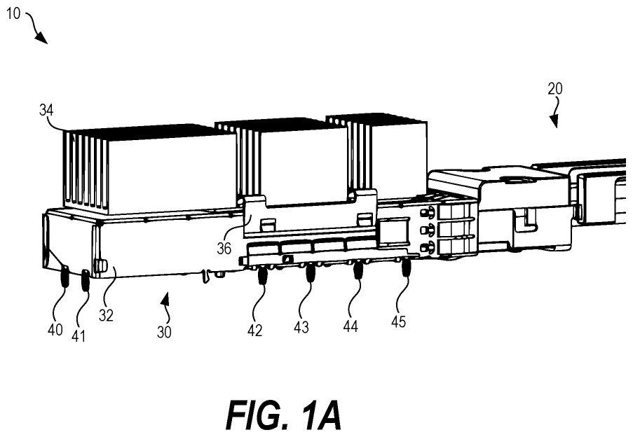

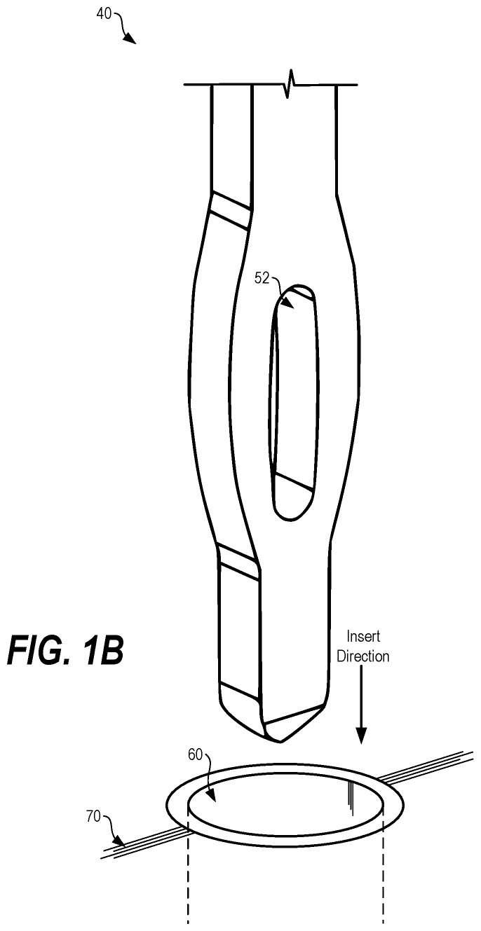

Turning to the drawings, FIG. 1A illustrates a perspective view of an example interconnect assembly 10 according to various embodiments of the present disclosure. The interconnect assembly 10 is representative, not drawn to any particular scale, and is illustrated to provide context for the concepts of the reworkable press-fit legs described herein. The press-fit legs described herein are not intended to be limited to use with any particular type of cage, housing, connector assembly, or other assembly.

The interconnect assembly 10 includes a cable assembly 20 and a cage 30, among other components. The cage 30 includes a metal housing 32, a heat sink 34, and a clip 36 that secures the heat sink 34 over the metal housing 32, among other components. The cable assembly 20 includes a pluggable transceiver module at one end of a cable. The metal housing 32 of the cage 30 surrounds an open space into which the module can be inserted, as would be understood in the field. The cage 30 includes a number of attachment legs 40-45. The legs 40-45, among possibly others that are obscured from view in FIG. 1A, extend down from the sidewalls of the cage 30. The legs 40-45 can be relied upon to position and secure the cage 30 over a PCB, for example, or other mounting substrates or structures.

FIG. 1B illustrates the attachment leg 40 shown in FIG. 1A. The leg 40 is illustrated as a representative example of a leg or pin that can be relied upon to secure the cage 30 or another housing, structure, or assembly over a mounting substrate or surface. The leg 40 extends down from a sidewall of the cage 30, as shown in FIG. 1A. The cage 30 includes other legs 41-45 that are similar to the leg 40, and the legs 40-45 can be relied upon to position and secure the cage 30 over a PCB, as one example of a mounting substrate.

The leg 40 can be inserted into an aperture 60 of a PCB in the direction shown in FIG. 1. The aperture 60 can extend through the PCB in one example. That is, the aperture 60 may extend entirely through the PCB, from the top surface 70 to a bottom or back surface (not shown) of the PCB. Thus, the aperture 60 can be a through-hole or via that extends through the PCB, and the aperture 60 may be plated with one or more metals or metal layers in some cases. Once the leg 40 is inserted into the aperture 60, the leg 40 can be held in place by friction (e.g., a friction- or interference-fit). In some cases, the aperture 60 can also be heated and filled with solder, conductive epoxy, an insulating epoxy, or other filler material(s) that surround the leg 40 within the aperture 60.

The leg 40 is one example of an attachment leg that can be relied upon to mechanically secure cages, housings, and other structures on or over PCBs and other substrates. Other legs may have different structures or structural features but serve a similar purpose. One problem with the leg 40, among others, is that it may deform after being inserted into the aperture 60. For example, the leg 40 includes an eyelet 52, and the eyelet 52 may close or deform to some extent when the leg 40 is inserted into the aperture 60, due to mechanical interference between the outer surfaces of the leg 40 and the inner surfaces of the aperture 60. While this mechanical interference may be intended to provide a friction-fit, the eyelet 52 may remain closed even if the leg 40 is removed from the aperture 60. The leg 40 may then be unsuitable for reinsertion back into the aperture 60, into another aperture of the PCB, or another aperture of another PCB as part of a rework process. Thus, an assembly including the leg 40 may not be suitable for use after it is removed from the top surface 70 of the PCB. Assemblies including the leg 40, among others, may need to be discarded if rework is necessary.

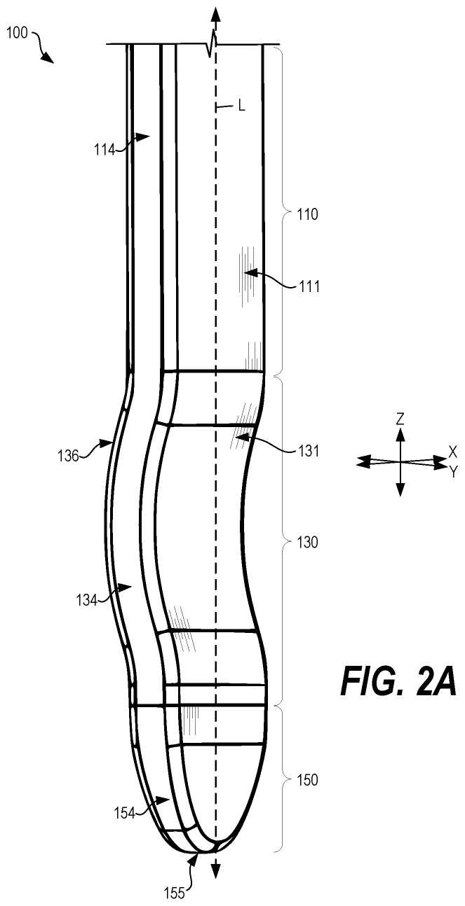

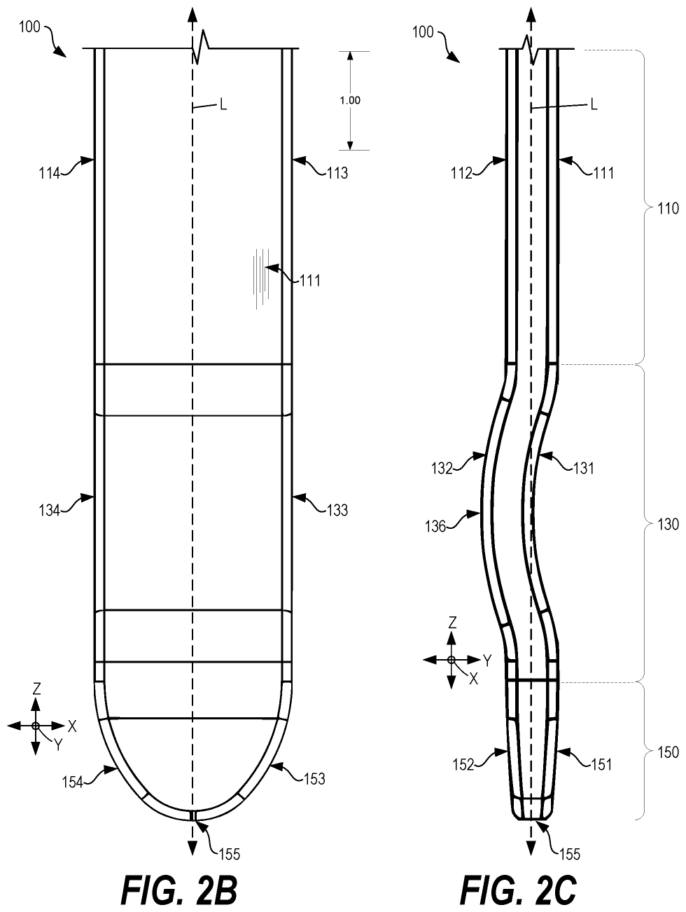

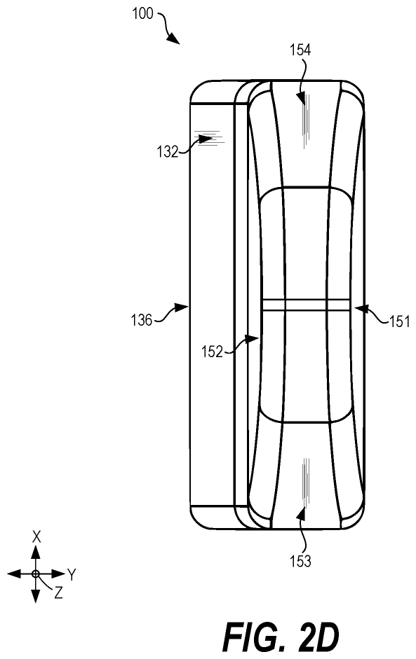

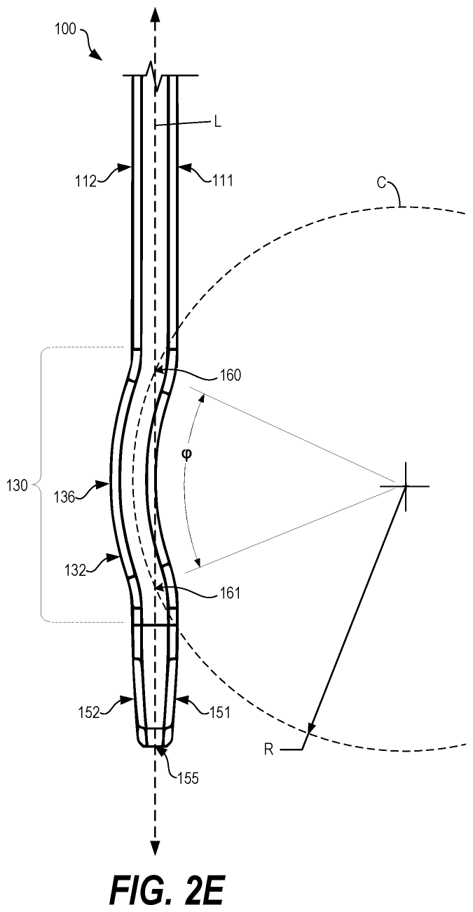

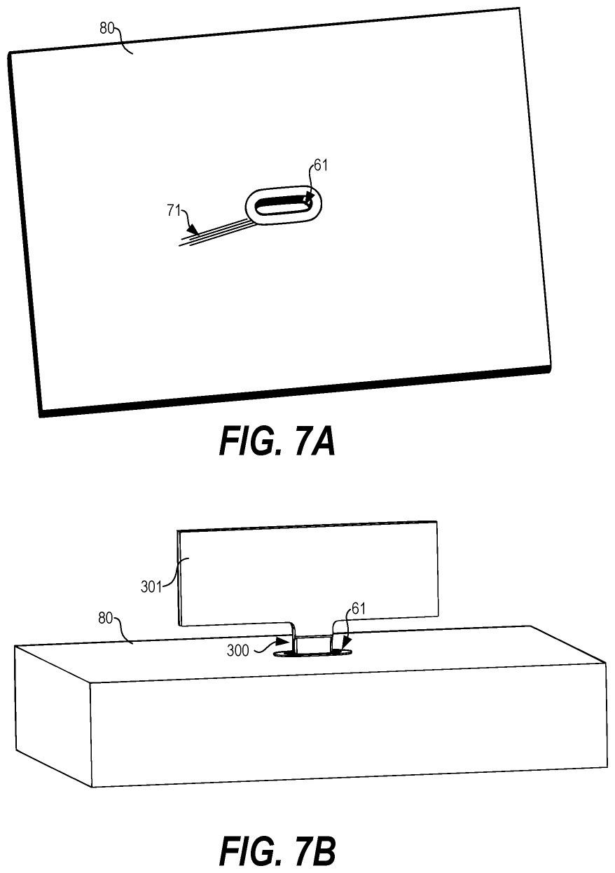

A number of embodiments of press-fit legs are described below with reference to FIGS. 2A-2E, 3A-3D, 4A-4D, and 5A-5D. The press-fit legs include bent beam regions and a number of separated bent beams in some cases. The bent beam regions and bent beams are compressible and can extend in length to some extent when inserted into mounting apertures. The structural aspects and features of the press-fit legs are described below with reference to FIGS. 2A-2E, 3A-3D, 4A-4D, and 5A-5D, and the function and use of the press-fit legs are then described with reference to FIGS. 7A and 7B.

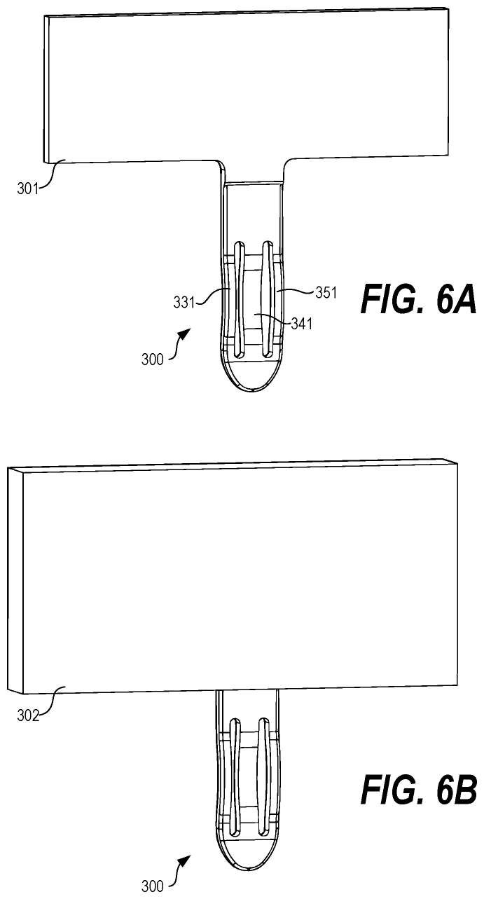

FIG. 2A illustrates a perspective view of a press-fit leg 100 (“leg 100”) according to various aspects of the embodiments described herein. FIG. 2B illustrates a first side view, FIG. 2C illustrates a second side view, and FIG. 2D illustrates a bottom-up view of the press-fit leg 100 shown in FIG. 2A. The leg 100 is illustrated as a representative example of a reworkable press-fit leg according to the concepts described herein. The leg 100 is not necessarily drawn to any particular size or scale, and the exact dimensions of the leg 100 can vary among the embodiments. The leg 100 can be relied upon to mechanically secure cages, housings, and other structures on or over PCBs and other substrates. As described in further detail below with reference to FIGS. 6A and 6B, the leg 100 can extend down from the edge of a sidewall of a cage of a connector assembly, as one example. The leg 100 can be formed integrally with the sidewall, in one case, or the leg 100 can be formed separately and molded or otherwise attached to the sidewall.

Referring among FIGS. 2A-2D, the leg 100 includes a flat beam extension region 110, a bent beam region 130, and a head region 150. Extending along a central longitudinal axis “L” of the leg 100, the bent beam region 130 of the leg 100 is positioned between the flat beam extension region 110 and the head region 150 of the leg 100. As best shown in FIGS. 2B and 2C, the flat beam extension region 110 includes a first major lateral surface 111, a second major lateral surface 112, a first minor side surface 113, and a second minor side surface 114. The first major lateral surface 111 and the second major lateral surface 112 extend in two different, parallel planes. The first minor side surface 113 and the second minor side surface 114 also extend in two different, parallel planes. The first and second minor side surfaces 113 and 114 extend in planes that intersect orthogonally with the planes in which the first and second major side surfaces 111 and 112 extend in the example shown. Thus, the flat beam extension region 110 is formed as a type of elongated, rectangular cuboid. The surfaces 111 and 112 are “major” surfaces, as compared to the “minor” surfaces 113 and 114, because the surfaces 111 and 112 are relatively larger in surface area than the surfaces 113 and 114.

The bent beam region 130 includes a first major curved surface 131, a second major curved surface 132, a first minor side surface 133, and a second minor side surface 134. The first major curved surface 131 and the second major curved surface 132 are curved surfaces. The first minor side surface 133 and the second minor side surface 134 extend in two different, parallel planes. The surfaces 131 and 132 are “major” surfaces, as compared to the “minor” surfaces 133 and 134, because the surfaces 131 and 132 are relatively larger in surface area than the surfaces 133 and 134. As best shown in FIG. 2A, the flat beam extension region 110 is formed as a type of cylindrical section or portion of a cylinder.

Starting from the flat beam extension region 110, the bent beam region 130 curves apart and away from the central longitudinal axis “L” of the leg 100, to the apex 136 of the bent beam region 130. From the apex 136, the bent beam region 130 curves back toward the central longitudinal axis “L” of the leg 100, meeting the head region 150. The apex 136 is the furthest point of extension or curvature of the bent beam region 130 apart from the flat beam extension region 110 and the head region 150. Additional aspects of the bent beam region 130 are described below with reference to FIG. 2E.

The head region 150 of the leg 100 includes a first lateral surface 151, a second lateral surface 152, a first curved side surface 153, and a second curved side surface 154. The first lateral surface 151 and the second lateral surface 152 taper towards each other along the longitudinal axis “L” of the leg 100, towards the distal end 155 of the leg 100. The first curved side surface 153 and the second curved side surface 154 curve towards each other as they approach the distal end 155. The distal end 155 of the leg 100 is curved in shape.

FIG. 2E illustrates another side view of the leg 100 shown in FIG. 2A. FIG. 2E illustrates how the bent beam region 130 of the leg 100 extends along a segment of the circle “C”. The segment is defined between a chord of the circle “C.” which also extends between the points 160 and 161 where the central longitudinal axis “L” of the leg 100 intersects the circle “C”. The radius “R” of the circle “C” can vary among the embodiments. Additionally, the bent beam region 130 can extend along other segments of the circle “C”. In the example shown, the bent beam region 130 extends along a segment of the circumference of the circle “C” that is defined by the angle “φ”. The angle φ is about 45° in the example shown, but φ can range in other embodiments. An example range for φ includes 30-60°, although larger or smaller ranges can be relied upon. Other examples of φ include about 30°, about 35°, about 40°, about 45°, about 50°, about 55°, and about 60°.

The leg 100 is integrally formed from the same material. In one example, the leg 100 can be formed by stamping or shearing the leg 100 out from a sheet of metal, metal alloy, or metal composite materials, to form a leg blank. If needed, the edges, curves, and other features of the flat beam extension region 110, the bent beam region 130, and the head region 150 can be bent or otherwise formed from the stamped leg blank. In some cases, the curvature of the bent beam region 130 can be formed or achieved in a separate forming step starting from the leg blank. Similarly, the tapers and curves of the head region 150 can be formed or achieved in a separate forming step starting from the leg blank. However, the stamping and forming steps can occur in the same or combined process steps in some cases. In other cases, the leg 100 can be formed using molding or other additive or subtractive process techniques, and the leg 100 can also be formed from plastics, polymers, and other types of materials in some cases. The leg 100 can be formed from a range of different materials, with a preference for materials that are sufficiently ductile to permit the bent beam region 130 to be compressed toward and extended along the longitudinal axis “L”, when the leg 100 is inserted into an elongated aperture, as described below with reference to FIGS. 7A and 7B.

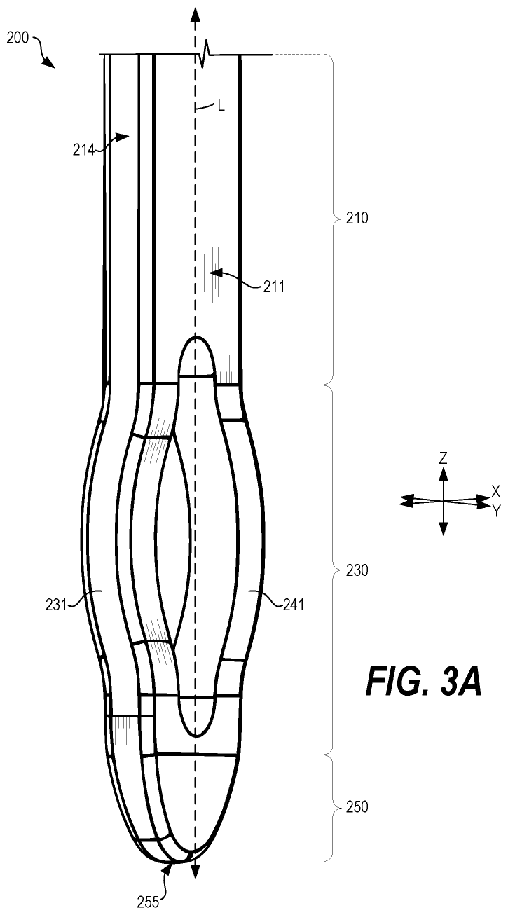

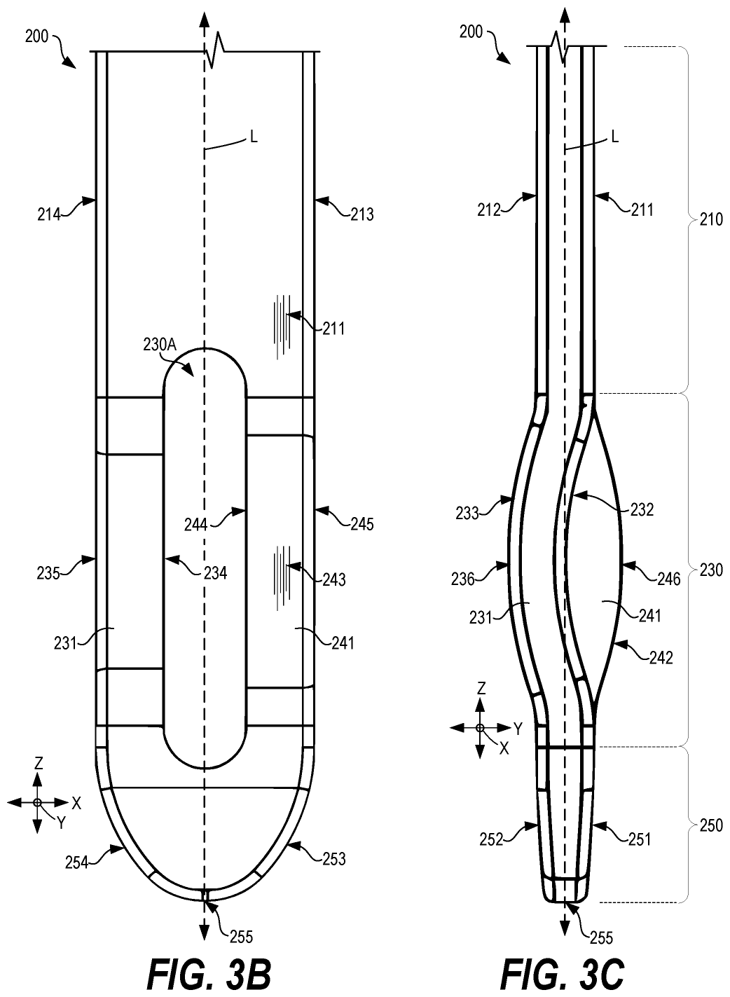

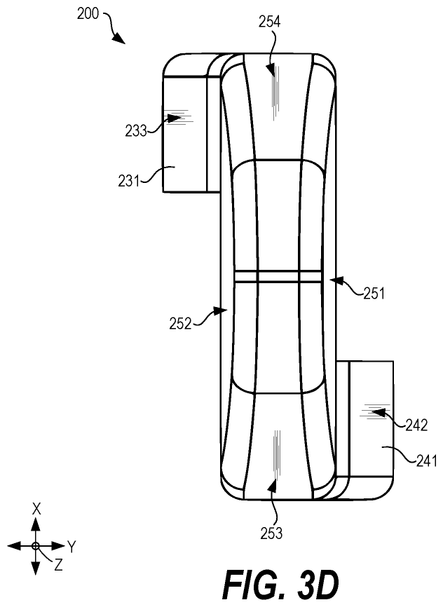

FIG. 3A illustrates a perspective view of a press-fit leg 200 (“leg 200”) according to various aspects of the embodiments described herein. FIG. 3B illustrates a first side view, FIG. 3C illustrates a second side view, and FIG. 3D illustrates a bottom-up view of the press-fit leg 200 shown in FIG. 3A. The leg 200 is illustrated as a representative example of a reworkable press-fit leg according to the concepts described herein. The leg 200 is not necessarily drawn to any particular size or scale, and the exact dimensions of the leg 200 can vary among the embodiments. The leg 200 can be relied upon to mechanically secure cages, housings, and other structures on or over PCBs and other substrates. As described in further detail below with reference to FIGS. 6A and 6B, the leg 200 can extend down from the edge of a sidewall of a cage of a connector assembly, as one example. The leg 200 can be formed integrally with the sidewall, in one case, or the leg 200 can be formed separately and molded or otherwise attached to the sidewall.

Referring among FIGS. 3A-3D, the leg 200 includes a flat beam extension region 210, a bent beam region 230, and a head region 250. Extending along a central longitudinal axis “L” of the leg 200, the bent beam region 230 of the leg 200 is positioned between the flat beam extension region 210 and the head region 250 of the leg 200. As best shown in FIGS. 3B and 3C, the flat beam extension region 210 includes a first major lateral surface 211, a second major lateral surface 212, a first minor side surface 213, and a second minor side surface 214. The first major lateral surface 211 and the second major lateral surface 212 extend in two different, parallel planes. The first minor side surface 213 and the second minor side surface 214 also extend in two different, parallel planes. In the example shown, the first and second minor side surfaces 213 and 214 extend in planes that intersect orthogonally with the planes in which the first and second major side surfaces 211 and 212 extend. Thus, the flat beam extension region 210 is formed as a type of elongated, rectangular cuboid. The surfaces 211 and 212 are “major” surfaces, as compared to the “minor” surfaces 213 and 214, because the surfaces 211 and 212 are relatively larger in surface area than the surfaces 213 and 214.

The bent beam region 230 includes a first bent beam 231 and a second bent beam 241, with a longitudinal slit 230A separating the first bent beam 231 and the second bent beam 241. The longitudinal slit 230A is an aperture or opening in the bent beam region 230, between the first bent beam 231 and the second bent beam 241. As best shown in FIGS. 3A and 3D, the first bent beam 231 and the second bent beam 241 are counter-extending bent beams, because they extend or bend in opposite directions as compared to each other. The longitudinal slit 230A extends longitudinally parallel to the longitudinal axis “L” of the leg 200.

Referring between FIGS. 3B and 3C, the first bent beam 231 includes a first curved surface 232, a second curved surface 233, a first side surface 234, and a second side surface 235. The first curved surface 232 and the second curved surface 233 are curved surfaces. The first side surface 234 and the second side surface 235 are flat and extend in two different, parallel planes. The second bent beam 241 includes a first curved surface 242, a second curved surface 243, a first side surface 244, and a second side surface 245. The first curved surface 242 and the second curved surface 243 are curved surfaces. The first side surface 244 and the second side surface 245 are flat and extend in two different, parallel planes.

Starting from the flat beam extension region 210, the first bent beam 231 curves in a first direction apart and away from the central longitudinal axis “L” of the leg 200, to the apex 236 of the first bent beam 231. From the apex 236, the first bent beam 231 curves back toward the central longitudinal axis “L” of the leg 200, meeting the head region 250. The apex 236 is the furthest point of extension or curvature of the first bent beam 231 apart from the flat beam extension region 210 and the head region 250. Starting from the flat beam extension region 210, the second bent beam 241 curves in a second direction, opposite from the first direction, apart and away from the central longitudinal axis “L” of the leg 200, to the apex 246 of the second bent beam 241. From the apex 246, the second bent beam 241 curves back toward the central longitudinal axis “L” of the leg 200, meeting the head region 250. The apex 246 is the furthest point of extension or curvature of the second bent beam 241 apart from the flat beam extension region 210 and the head region 250.

The head region 250 of the leg 200 includes a first lateral surface 251, a second lateral surface 252, a first curved side surface 253, and a second curved side surface 254. The first lateral surface 251 and the second lateral surface 252 taper towards each other along the longitudinal axis “L” of the leg 200, towards the distal end 255 of the leg 200. The first curved side surface 253 and the second curved side surface 254 curve towards each other as they approach the distal end 255. The distal end 255 of the leg 200 is curved in shape.

The first bent beam 231 of the leg 200 extends along a segment of a circle, similar to the way the bent beam region 130 of the leg 100 shown in FIG. 2E extends along a segment of the circle “C”. The radius of curvature of the first bent beam 231 can vary among the embodiments. The first bent beam 231 can also extend along other, larger or smaller, segments of a circle as compared to that shown. In the example shown, the first bent beam 231 extends along a segment of the circumference of a circle defined by an angle of about 45°, but the angle can range in other embodiments. An example range for the angle includes 30-60°, although larger or smaller ranges can be relied upon. Other example angles includes about 30°, about 35°, about 40°, about 45°, about 50°, about 55°, and about 60º.

The second bent beam 241 of the leg 200 also extends along a segment of a circle, similar to the way the bent beam region 130 of the leg 100 shown in FIG. 2E extends along a segment of the circle “C”. The radius of curvature of the second bent beam 241 can vary among the embodiments, although both the first bent beam 231 and the second bent beam 241 have the same radius of curvature in preferred embodiments. The second bent beam 241 can also extend along other, larger or smaller, segments of a circle as compared to that shown. In the example shown, the second bent beam 241 extends along a segment of the circumference of a circle defined by an angle of about 45°, but the angle can range in other embodiments. An example range for the angle includes 30-60°, although larger or smaller ranges can be relied upon. Other example angles includes about 30°, about 35°, about 40°, about 45°, about 50°, about 55°, and about 60°. In preferred embodiments, the first bent beam 231 and the second bent beam 241 extend the same length (e.g., extend along segments of a circle having the same length).

The leg 200 is integrally formed from the same material. In one example, the leg 200 can be formed by stamping or shearing the leg 200 out from a sheet of metal, metal alloy, or metal composite materials, to form a leg blank. If needed, the edges, curves, and other features of the flat beam extension region 210, the bent beam region 230, and the head region 250 can be bent or otherwise formed from the stamped leg blank. In some cases, the curvature of the first bent beam 231 and the second bent beam 241 can be formed or achieved in a separate forming steps starting from the leg blank. Similarly, the tapers and curves of the head region 250 can be formed or achieved in a separate forming step starting from the leg blank. However, the stamping and forming steps can occur in the same or combined process steps in some cases. In other cases, the leg 200 can be formed using molding or other additive or subtractive process techniques, and the leg 200 can also be formed from plastics, polymers, and other types of materials in some cases. The leg 200 can be formed from a range of different materials, with a preference for materials that are sufficiently ductile to permit the first bent beam 231 and the second bent beam 241 to be compressed into closer alignment toward each other and extended in length along the longitudinal axis “L”, when the leg 200 is inserted into an elongated aperture, as described below with reference to FIGS. 7A and 7B.

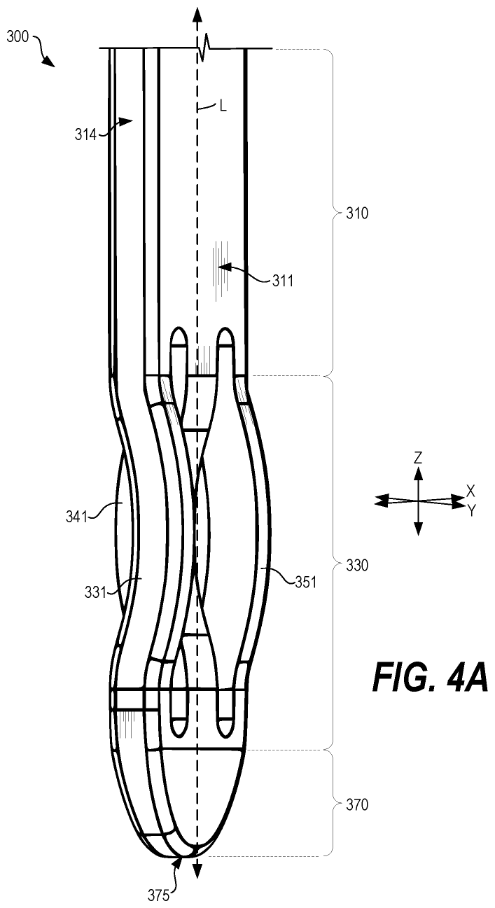

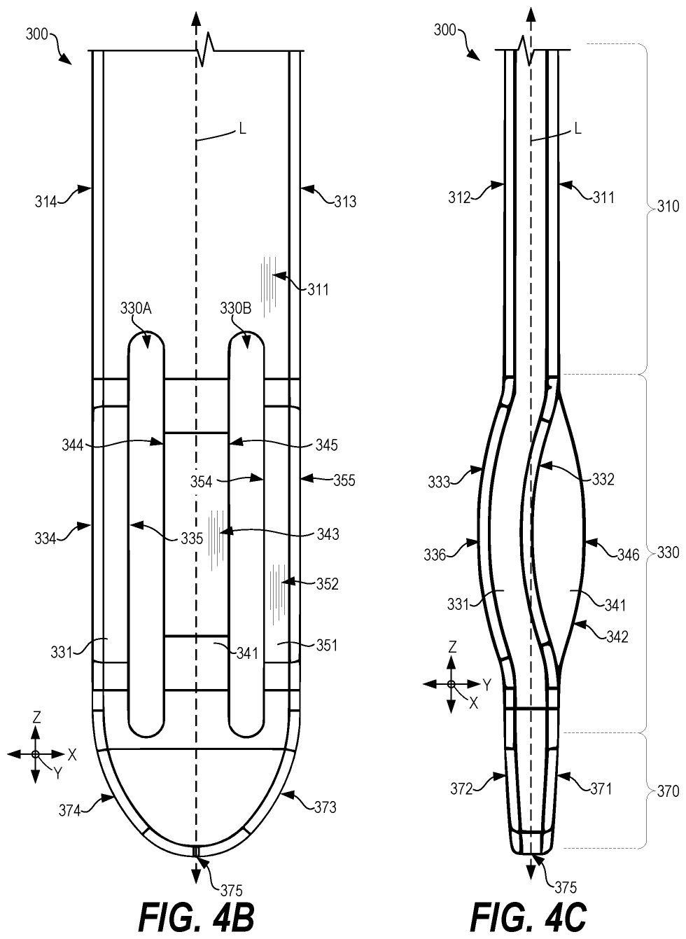

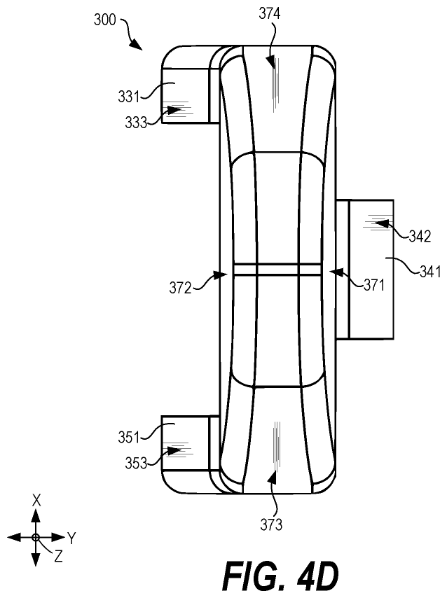

FIG. 4A illustrates a perspective view of a press-fit leg 300 (“leg 300”) according to various aspects of the embodiments described herein. FIG. 4B illustrates a first side view, FIG. 4C illustrates a second side view, and FIG. 4D illustrates a bottom-up view of the press-fit leg 300 shown in FIG. 4A. The leg 300 is illustrated as a representative example of a reworkable press-fit leg according to the concepts described herein. The leg 300 is not necessarily drawn to any particular size or scale, and the exact dimensions of the leg 300 can vary among the embodiments. The leg 300 can be relied upon to mechanically secure cages, housings, and other structures on or over PCBs and other substrates. As described in further detail below with reference to FIGS. 6A and 6B, the leg 300 can extend down from the edge of a sidewall of a cage of a connector assembly, as one example. The leg 300 can be formed integrally with the sidewall, in one case, or the leg 300 can be formed separately and molded or otherwise attached to the sidewall.

Referring among FIGS. 4A-4D, the leg 300 includes a flat beam extension region 310, a bent beam region 330, and a head region 370. Extending along a central longitudinal axis “L” of the leg 300, the bent beam region 330 of the leg 300 is positioned between the flat beam extension region 310 and the head region 370 of the leg 300. As best shown in FIGS. 4B and 4C, the flat beam extension region 310 includes a first major lateral surface 311, a second major lateral surface 312, a first minor side surface 313, and a second minor side surface 314. The first major lateral surface 311 and the second major lateral surface 312 extend in two different, parallel planes. The first minor side surface 313 and the second minor side surface 314 also extend in two different, parallel planes. In the example shown, the first and second minor side surfaces 313 and 314 extend in planes that intersect orthogonally with the planes in which the first and second major side surfaces 311 and 312 extend. Thus, the flat beam extension region 310 is formed as a type of elongated, rectangular cuboid. The surfaces 311 and 312 are “major” surfaces, as compared to the “minor” surfaces 313 and 314, because the surfaces 311 and 312 are relatively larger in surface area than the surfaces 313 and 314.

The bent beam region 330 includes a first bent beam 331, a second bent beam 341, and a third bent beam 351. A longitudinal slit 330A separates the first bent beam 331 and the second bent beam 341. A longitudinal slit 330B separates the second bent beam 341 and the third bent beam 351. The longitudinal slits 330A and 330B are apertures or openings in the bent beam region 330, between the first bent beam 331, the second bent beam 341, and the third bent beam 351. The longitudinal slits 330A and 330B extend longitudinally parallel to the longitudinal axis “L” of the leg 200.

As best shown in FIGS. 4A and 4D, the first bent beam 331 and the second bent beam 341 are counter-extending bent beams, because they extend or bend in opposite directions as compared to each other. Similarly, the second bent beam 341 and the third bent beam 351 are counter-extending bent beams, because they extend or bend in opposite directions as compared to each other. The first bent beam 331 and the third bent beam 351 extend or bend in the same direction.

Referring between FIGS. 4B and 4C, the first bent beam 331 includes a first curved surface 332, a second curved surface 333, a first side surface 334, and a second side surface 335. The first curved surface 332 and the second curved surface 333 are curved surfaces. The first side surface 334 and the second side surface 335 are flat and extend in two different, parallel planes. The second bent beam 341 includes a first curved surface 342, a second curved surface 343, a first side surface 344, and a second side surface 345. The first curved surface 342 and the second curved surface 343 are curved surfaces. The first side surface 344 and the second side surface 345 are flat and extend in two different, parallel planes. The third bent beam 351 includes a first curved surface 352, a second curved surface (occluded from view), a first side surface 354, and a second side surface 355.

Starting from the flat beam extension region 310, the first bent beam 331 curves in a first direction apart and away from the central longitudinal axis “L” of the leg 300, to the apex 336 of the first bent beam 331. From the apex 336, the first bent beam 331 curves back toward the central longitudinal axis “L” of the leg 300, meeting the head region 370). The apex 336 is the furthest point of extension or curvature of the first bent beam 331 apart from the flat beam extension region 310 and the head region 370. Starting from the flat beam extension region 310, the second bent beam 341 curves in a second direction, opposite from the first direction, apart and away from the central longitudinal axis “L” of the leg 300, to the apex 346 of the second bent beam 341. From the apex 346, the second bent beam 341 curves back toward the central longitudinal axis “L” of the leg 300, meeting the head region 370. The apex 346 is the furthest point of extension or curvature of the second bent beam 341 apart from the flat beam extension region 310 and the head region 370. Starting from the flat beam extension region 310, the third bent beam 351 curves in the first direction, opposite from the second direction, apart and away from the central longitudinal axis “L” of the leg 300, to an apex of the third bent beam 351. From the apex, the third bent beam 351 curves back toward the central longitudinal axis “L” of the leg 300, meeting the head region 370.

The head region 370) of the leg 300 includes a first lateral surface 371, a second lateral surface 372, a first curved side surface 373, and a second curved side surface 374. The first lateral surface 371 and the second lateral surface 372 taper towards each other along the longitudinal axis “L” of the leg 300, towards the distal end 375 of the leg 300. The first curved side surface 373 and the second curved side surface 374 curve towards each other as they approach the distal end 375. The distal end 375 of the leg 300 is curved in shape.

The first bent beam 331 of the leg 300 extends along a segment of a circle, similar to the way the bent beam region 130 of the leg 100 shown in FIG. 2E extends along a segment of the circle “C”. The radius of curvature of the first bent beam 331 can vary among the embodiments. The first bent beam 331 can also extend along other, larger or smaller, segments of a circle as compared to that shown. In the example shown, the first bent beam 331 extends along a segment of the circumference of a circle defined by an angle of about 45°, but the angle can range in other embodiments. An example range for the angle includes 30-60°, although larger or smaller ranges can be relied upon. Other example angles includes about 30°, about 35°, about 40°, about 45°, about 50°, about 55°, and about 60°.

The second bent beam 341 of the leg 300 also extends along a segment of a circle, similar to the way the bent beam region 130 of the leg 100 shown in FIG. 2E extends along a segment of the circle “C”. The radius of curvature of the second bent beam 341 can vary among the embodiments, although the first bent beam 331, the second bent beam 341, and the third bent beam 351 have the same radius of curvature in preferred embodiments. The second bent beam 341 can also extend along other, larger or smaller, segments of a circle as compared to that shown. In the example shown, the second bent beam 341 extends along a segment of the circumference of a circle defined by an angle of about 45°, but the angle can range in other embodiments. An example range for the angle includes 30-60°, although larger or smaller ranges can be relied upon. Other example angles includes about 30°, about 35°, about 40°, about 45°, about 50°, about 55°, and about 60°.

The third bent beam 351 of the leg 300 also extends along a segment of a circle, similar to the way the bent beam region 130 of the leg 100 shown in FIG. 2E extends along a segment of the circle “C”. The radius of curvature of the third bent beam 351 can vary among the embodiments, although the first bent beam 331, the second bent beam 341, and the third bent beam 351 have the same radius of curvature in preferred embodiments. The third bent beam 351 can also extend along other, larger or smaller, segments of a circle as compared to that shown. In the example shown, the third bent beam 351 extends along a segment of the circumference of a circle defined by an angle of about 45°, but the angle can range in other embodiments. An example range for the angle includes 30-60°, although larger or smaller ranges can be relied upon. Other example angles includes about 30°, about 35°, about 40°, about 45°, about 50°, about 55°, and about 60°. In preferred embodiments, the first bent beam 331, the second bent beam 341, and the third bent beam 351 extend the same length (e.g., extend along segments of a circle having the same length).

The leg 300 is integrally formed from the same material. In one example, the leg 300 can be formed by stamping or shearing the leg 300 out from a sheet of metal, metal alloy, or metal composite materials, to form a leg blank. If needed, the edges, curves, and other features of the flat beam extension region 310, the bent beam region 330, and the head region 370 can be bent or otherwise formed from the stamped leg blank. In some cases, the curvature of the first bent beam 331, the second bent beam 341, and the third bent beam 351 can be formed or achieved in a separate forming steps starting from the leg blank. Similarly, the tapers and curves of the head region 370) can be formed or achieved in a separate forming step starting from the leg blank. However, the stamping and forming steps can occur in the same or combined process steps in some cases. In other cases, the leg 300 can be formed using molding or other additive or subtractive process techniques, and the leg 300 can also be formed from plastics, polymers, and other types of materials in some cases. The leg 300 can be formed from a range of different materials, with a preference for materials that are sufficiently ductile to permit the bent beams 331, 341, and 351 to be compressed into closer alignment toward each other and extended in length along the longitudinal axis “L”, when the leg 300 is inserted into an elongated aperture, as described below with reference to FIGS. 7A and 7B.

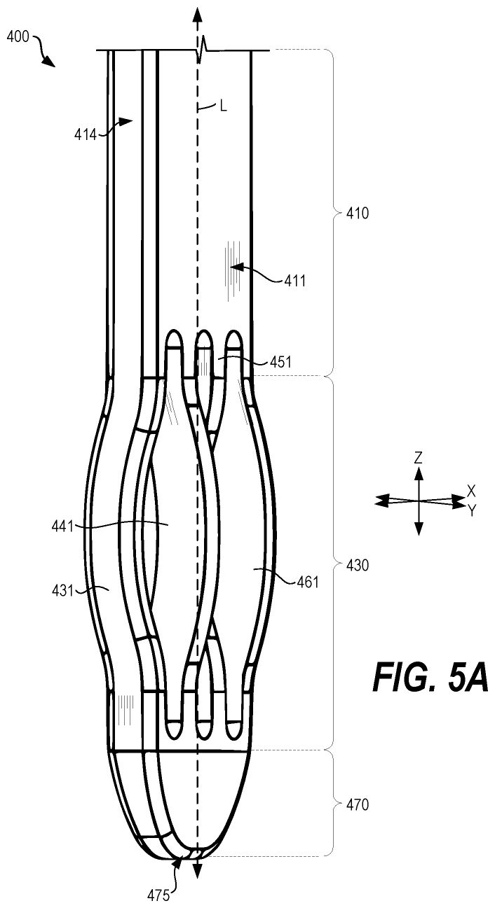

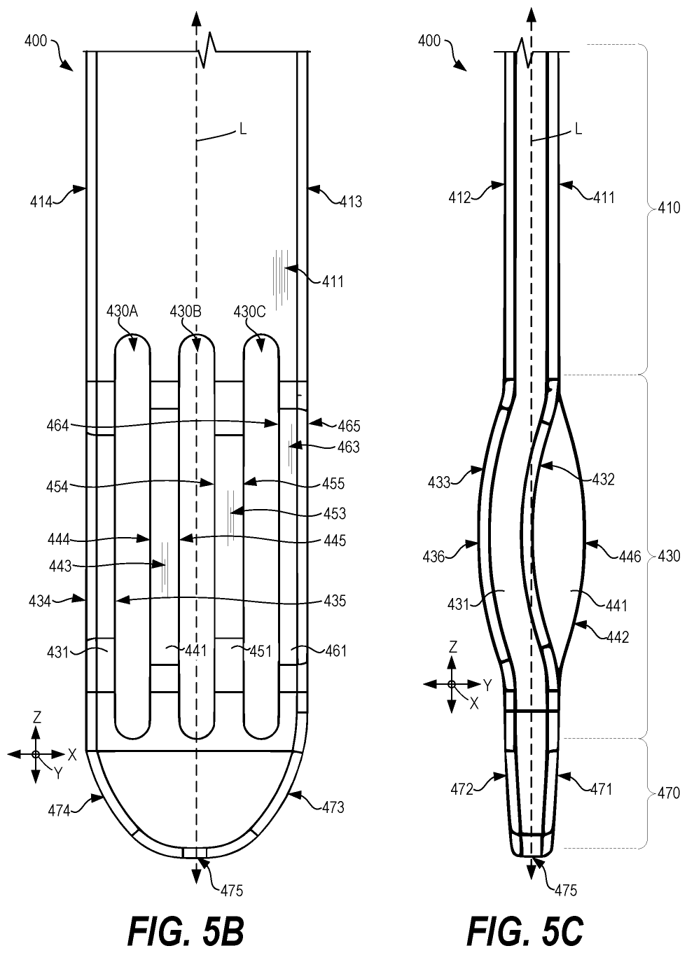

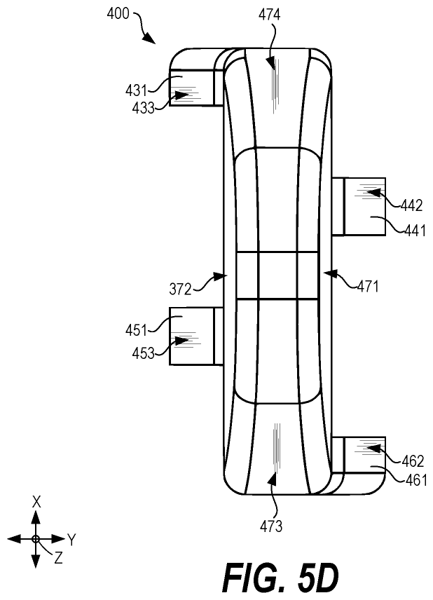

FIG. 5A illustrates a perspective view of a press-fit leg 400 (“leg 400”) according to various aspects of the embodiments described herein. FIG. 5B illustrates a first side view, FIG. 5C illustrates a second side view, and FIG. 5D illustrates a bottom-up view of the press-fit leg 400 shown in FIG. 5A. The leg 400 is illustrated as a representative example of a reworkable press-fit leg according to the concepts described herein. The leg 400 is not necessarily drawn to any particular size or scale, and the exact dimensions of the leg 400 can vary among the embodiments. The leg 400 can be relied upon to mechanically secure cages, housings, and other structures on or over PCBs and other substrates. As described in further detail below with reference to FIGS. 6A and 6B, the leg 400 can extend down from the edge of a sidewall of a cage of a connector assembly, as one example. The leg 400 can be formed integrally with the sidewall, in one case, or the leg 400 can be formed separately and molded or otherwise attached to the sidewall.

Referring among FIGS. 5A-5D, the leg 400 includes a flat beam extension region 410, a bent beam region 430, and a head region 470. Extending along a central longitudinal axis “L” of the leg 400, the bent beam region 430 of the leg 400 is positioned between the flat beam extension region 410 and the head region 470 of the leg 400. As best shown in FIGS. 5B and 5C, the flat beam extension region 410 includes a first major lateral surface 411, a second major lateral surface 412, a first minor side surface 413, and a second minor side surface 414. The first major lateral surface 411 and the second major lateral surface 412 extend in two different, parallel planes. The first minor side surface 413 and the second minor side surface 414 also extend in two different, parallel planes. In the example shown, the first and second minor side surfaces 413 and 414 extend in planes that intersect orthogonally with the planes in which the first and second major side surfaces 411 and 412 extend. Thus, the flat beam extension region 410 is formed as a type of elongated, rectangular cuboid. The surfaces 411 and 412 are “major” surfaces, as compared to the “minor” surfaces 413 and 414, because the surfaces 411 and 412 are relatively larger in surface area than the surfaces 413 and 414.

The bent beam region 430 includes a first bent beam 431, a second bent beam 441, a third bent beam 451, and a fourth bent beam 461. A longitudinal slit 430A separates the first bent beam 431 and the second bent beam 441. A longitudinal slit 430B separates the second bent beam 441 and the third bent beam 451. A longitudinal slit 430C separates the third bent beam 451 and the fourth bent beam 461. The longitudinal slits 430A, 430B, and 430C are apertures or openings in the bent beam region 430, between the first, second, third, and fourth bent beams 431, 441, 451, and 461. As best shown in FIGS. 5A and 5D, the first bent beam 431 and the second bent beam 441 are counter-extending bent beams, because they extend or bend in opposite directions as compared to each other. Similarly, the second bent beam 441 and the third bent beam 451 are counter-extending bent beams, because they extend or bend in opposite directions as compared to each other. The first bent beam 431 and the third bent beam 451 extend or bend in the same direction. The second bent beam 441 and the fourth bent beam 461 also extend or bend in the same direction.

Referring between FIGS. 5B-5D, the first bent beam 431 includes a first curved surface 432, a second curved surface 433, a first side surface 434, and a second side surface 435. The first curved surface 432 and the second curved surface 433 are curved surfaces. The first side surface 434 and the second side surface 435 are flat and extend in two different, parallel planes. The second bent beam 441 includes a first curved surface 442, a second curved surface 443, a first side surface 444, and a second side surface 445. The first curved surface 442 and the second curved surface 443 are curved surfaces. The first side surface 444 and the second side surface 445 are flat and extend in two different, parallel planes. The third bent beam 451 includes a first curved surface (occluded from view), a second curved surface 453, a first side surface 454, and a second side surface 455. The fourth bent beam 461 includes a first curved surface 462, a second curved surface 463, a first side surface 464, and a second side surface 465.

Starting from the flat beam extension region 410, the first bent beam 431 curves in a first direction apart and away from the central longitudinal axis “L” of the leg 400, to the apex 436 of the first bent beam 431. From the apex 436, the first bent beam 431 curves back toward the central longitudinal axis “L” of the leg 400, meeting the head region 470. The apex 436 is the furthest point of extension or curvature of the first bent beam 431 apart from the flat beam extension region 410 and the head region 470. Starting from the flat beam extension region 410, the second bent beam 441 curves in a second direction, opposite from the first direction, apart and away from the central longitudinal axis “L” of the leg 400, to the apex 446 of the second bent beam 441. From the apex 446, the second bent beam 441 curves back toward the central longitudinal axis “L” of the leg 400, meeting the head region 470. The apex 446 is the furthest point of extension or curvature of the second bent beam 441 apart from the flat beam extension region 410 and the head region 470.

Starting from the flat beam extension region 410, the third bent beam 451 curves in the first direction, opposite from the second direction, apart and away from the central longitudinal axis “L” of the leg 400, to an apex of the third bent beam 451. From the apex, the third bent beam 451 curves back toward the central longitudinal axis “L” of the leg 400, meeting the head region 470. Starting from the flat beam extension region 410, the fourth bent beam 461 curves in the second direction, opposite from the first direction, apart and away from the central longitudinal axis “L” of the leg 400, to an apex of the fourth bent beam 461. From the apex, the fourth bent beam 461 curves back toward the central longitudinal axis “L” of the leg 400, meeting the head region 470.

The head region 470 of the leg 400 includes a first lateral surface 471, a second lateral surface 472, a first curved side surface 473, and a second curved side surface 474. The first lateral surface 471 and the second lateral surface 472 taper towards each other along the longitudinal axis “L” of the leg 400, towards the distal end 475 of the leg 400. The first curved side surface 473 and the second curved side surface 474 curve towards each other as they approach the distal end 475. The distal end 475 of the leg 100 is curved in shape.

The first, second, third, and fourth bent beams 431, 441, 451, and 461 of the leg 400 each extend along a segment of a circle, similar to the way the bent beam region 130 of the leg 100 shown in FIG. 2E extends along a segment of the circle “C”. The radius of curvature of the bent beams 431, 441, 451, and 461 can vary among the embodiments. The bent beams 431, 441, 451, and 461 can also extend along other, larger or smaller, segments of a circle as compared to that shown. In the example shown, the bent beams 431, 441, 451, and 461 extend along a segment of the circumference of a circle defined by an angle of about 45°, but the angle can range in other embodiments. An example range for the angle includes 30-60°, although larger or smaller ranges can be relied upon. Other example angles includes about 30°, about 35°, about 40°, about 45°, about 50°, about 55°, and about 60°.

The leg 400 is integrally formed from the same material. In one example, the leg 400 can be formed by stamping or shearing the leg 400 out from a sheet of metal, metal alloy, or metal composite materials, to form a leg blank. If needed, the edges, curves, and other features of the flat beam extension region 410, the bent beam region 430, and the head region 470 can be bent or otherwise formed from the stamped leg blank. In some cases, the curvature of the first bent beam 431, the second bent beam 441, and the third bent beam 451 can be formed or achieved in a separate forming steps starting from the leg blank. Similarly, the tapers and curves of the head region 470) can be formed or achieved in a separate forming step starting from the leg blank. However, the stamping and forming steps can occur in the same or combined process steps in some cases. In other cases, the leg 400 can be formed using molding or other additive or subtractive process techniques, and the leg 400 can also be formed from plastics, polymers, and other types of materials in some cases. The leg 400 can be formed from a range of different materials, with a preference for materials that are sufficiently ductile to permit the bent beams 431, 441, and 451 to be compressed into closer alignment toward each other and extended in length along the longitudinal axis “L”, when the leg 400 is inserted into an elongated aperture, as described below with reference to FIGS. 7A and 7B.

FIG. 6A illustrates an example of the press-fit leg 300 shown in FIG. 4B. The leg 300 is integrally formed by stamping or shearing the leg 300 out from the sheet of material 301, in the example shown. Additional legs can also be formed from the same sheet of material 301. The other legs described herein can be formed in a similar way from the sheet of material 301. The leg 300, among others, can also be formed into the sidewall of a cage, such as the cage 30 shown in FIG. 1, and the sheet of material 301 is representative of the sidewall of a cage. The legs described herein can also be incorporated into other cages, housings, connectors, and assemblies. Any number of legs can be incorporated into the assemblies. FIG. 6B illustrates an example of the press-fit leg 300, after being molded or inserted into a wall 302 of a housing. The wall 302 can be formed from a plastic or other polymer material, and the sheet of material 301 shown in FIG. 6A can be molded within the plastic or other polymer material.

FIG. 7A illustrates an example of an elongated aperture 61 through a PCB 80. The aperture 61 can be a through-hole or via that extends through the PCB 80, and the aperture 61 may be plated with one or more metals or metal layers in some cases. The aperture 61 can extend through the PCB 80 in one example. That is, the aperture 61 may extend entirely through the PCB 80, from the top surface 71 (see FIG. 7A) to a bottom or back surface (not shown) of the PCB 80. It is not necessary that the aperture 61 extend through the PCB 80 in all cases, however. The elongated aperture 61 is representative and can vary in size and shape in some cases. Additionally, although a single aperture is illustrated in FIG. 7A, the PCB 80 can include any number of apertures for any number of press-fit legs.

The press-fit legs described herein may be inserted into and secured within the elongated aperture 61. The dimensions of the elongated aperture 61 can be selected or tailored for use with the press-fit legs described herein, to provide a friction or compression fit between the press-fit legs and the elongated aperture 61. More particularly, the dimensions of the aperture 61 can be selected to be large enough for insertion of a press-fit leg, with the bent beam region or bent beams of the leg contacting and pressing against the longer, inner sidewalls of the aperture 61. As one example, the leg 300 can be secured within the elongated aperture 61 using a friction or compression fit based on the compression of the bent beams 331, 341, and 315 of the leg 300 within the aperture 61.

FIG. 7B illustrates an example of the leg 300 after being inserted into the aperture 61 of the PCB 80. As the leg 300 is inserted into the aperture 61, the bent beams 331, 341, and 315 of the leg 300 contact the sidewalls of the aperture 61. The bent beams 331, 341, and 315 are then compressed together within the aperture 61, elongating the bent beams 331, 341, and 315 to some extent. The leg 300 can be held in place by friction (e.g., a friction- or interference-fit) within the aperture 61, with the bent beams 331, 341, and 315 providing a force normal against the inner surfaces of the sidewalls of the aperture 61. In some cases, the aperture 61 can also be heated and filled with solder, conductive epoxy, an insulating epoxy, or other filler material(s) that surround the leg 300 within the aperture 61.

The leg 300 can also be removed from the aperture 61 and reinserted into the aperture 61 or another aperture of another PCB or substrate. That is, leg 300 and other press-fit legs described herein are suitable for insertion, removal, and reinsertion back into the aperture 61, into another aperture of the PCB 80, or into another aperture of another PCB, as part of a rework process. Thus, an assembly including the leg 300 is suitable for use after it is removed from the PCB 80. Assemblies including the leg 300, among other press-fit legs described herein, do not need to be discarded if rework is necessary.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising.” “including.” “having.” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and a manufactured product or assembly, such as the geometric dimensioning and tolerancing criteria described in the American Society of Mechanical Engineers (ASMER) Y14.5 and the related International Organization for Standardization (ISOR) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

At least the following is claimed:

1. A press-fit leg, comprising:
a flat beam extension region;
a bent beam region; and
a head region, wherein, extending along a longitudinal axis of the leg, the bent beam region of the leg is positioned between the flat beam extension region and the head region of the leg.

2. The press-fit leg of claim 1, wherein the bent beam region curves apart and away from the longitudinal axis of the leg.

3. The press-fit leg of claim 1, wherein the bent beam region of the leg extends along a segment of a circle.

4. The press-fit leg of claim 3, wherein the segment of the circle extends between a chord of the circle defined between points where the longitudinal axis of the leg intersects the circle.

5. The press-fit leg of claim 1, wherein the bent beam region comprises at least two counter-extending bent beams.

6. The press-fit leg of claim 5, wherein the at least two counter-extending bent beams are separated by at least one longitudinal slit in the bent beam region.

7. The press-fit leg of claim 6, wherein the at least one longitudinal slit extends longitudinally parallel to the longitudinal axis of the leg.

8. The press-fit leg of claim 1, wherein the leg comprises two lateral surfaces and two side surfaces.

9. The press-fit leg of claim 8, wherein, in the bent beam region, the two side surfaces extend parallel to the longitudinal axis of the leg and the two lateral surfaces are curved apart and away from the longitudinal axis of the leg.

10. The press-fit leg of claim 8, wherein, in the head region, the two lateral surfaces taper toward the longitudinal axis of the leg and the two side surfaces curve inward and toward the longitudinal axis of the leg.
